(19) United States
(12) Patent Application Publication
(10) Pub. No.: US 2007/0052380 A1
(43) Pub. Date: Mar. 8, 2007

(54) Fan

(76) Inventor: Chen-Hui Lai, Hsi Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/515,849

(22) Filed: Sep. 6, 2006

(30) Foreign Application Priority Data
Sep. 8, 2005 (TW) 94215468

(51) Int. Cl. H02P 7/06

(52) U.S. Cl. 318/254

(57) ABSTRACT

A fan includes a fan leaf having a rotor in the interior of the fan leaf, and a hollow frame. In the center of the interior of the hollow frame, there is a base for pivoting with the fan leaf. On the surface of the base, there is a stator. The stator is covered by the rotor in the fan leaf. There is a current switch between the stator and the power input terminal for controlling the current direction of the stator to control the fan leaf to rotate clockwise or counterclockwise.

### BACKGROUND OF THE INVENTION

1. Field of the Invention

The present invention relates to a fan. In particular, this invention relates to a fan that can be controlled to rotate clockwise or counterclockwise.

2. Description of the Related Art

As computer technology has developed, their performance has become higher, and generates large amounts of heat. Therefore, a high performance fan has to be installed in the computer's housing. The temperature in the computer can be lowered to a specified range that is acceptable for the electronic element so that the compute can work normally. The factors that damage its components and make the computer abnormally shut down are thereby reduced.

Generally, the fan in the housing exhausts the hot air from the housing to lower the temperature. The sucking fan in the housing sucks the cool air into the housing to blow onto and cool the electronic elements. The fan sucks or exhausts the air according to its operating status. When the computer has been operating for a long time, the heat generated from the CPU or the display chip is exhausted to the housing via the radiator so that the temperature in the housing rises. At this moment, an exhausting-air operation is used to exhaust the hot air from the interior of the housing. When the computer initially turns on, a sucking-air operation for the fan is used to make the radiator exhaust the heat effectively.

However, the rotating direction of the fan installed in the house of the prior art cannot be controlled according to its operating status. When a plurality of fans are installed in the housing, the fans cannot exhaust air or suck air simultaneously.

### SUMMARY OF THE INVENTION

One particular aspect of the present invention is to provide a fan in which the fan leaf can be controlled to rotate clockwise or counterclockwise.

The present invention uses a current switch to change the current direction of the stator so that the rotating direction is changed. Therefore, the goal of controlling the fan leaf to rotate clockwise or counterclockwise is achieved.

The fan includes a fan leaf having a rotor in the interior of the fan leaf, and a hollow frame. In the center of the interior of the hollow frame, there is a base for pivoting with the fan leaf. On the surface of the base, there is a stator covered by the fan leaf. The characteristic is that there is a current switch between the stator and the power input terminal for controlling the current direction of the stator to control the fan leaf to rotate clockwise or counterclockwise.

According to the embodiment of the present invention, the stator includes a driving coil that is connected with the power input terminal. An electric brake is used for controlling the current direction of the induction coil.

Thereby, the rotating direction of the fan leaf is controlled. According to the embodiment of the present invention, the rotor is a magnet having a fixed magnetic field.

According to the embodiment of the present invention, when the electric brake of the current switch is switched to the first position, the fan leaf inducts the magnetic field so that the fan leaf rotates clockwise. When the electric brake of the current switch is switched to the second position, the current inversely flows into the stator so that the fan leaf rotates counterclockwise due to the magnetic field generated from the stator changes.

According to the embodiment of the present invention, the rotor installed in the fan leaf generates a fixed magnetic field. The rotor is connected around the stator and repels the magnetic filed generated from the set of driving coil to rotate the fan leaf. Therefore, the magnetic filed generated from the stator determines the rotating direction of the fan leaf.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of the fan of the present invention;

FIG. 2 is a schematic diagram of the circuit of the fan of the present invention showing the electric brake of the switch located in a first position;

FIG. 3 is a schematic diagram of the circuit of the fan of the present invention showing the electric brake of the switch located in a second position; and

FIG. 4 is a schematic diagram of the circuit of the fan of the present invention showing the electric brake of the switch located in a third position.

### DETAILED DESCRIPTION OF THE PREFERRED EMBODIMENTS

A preferred embodiment and the attached diagrams are used to illustrate the technical means and functions of the present invention.

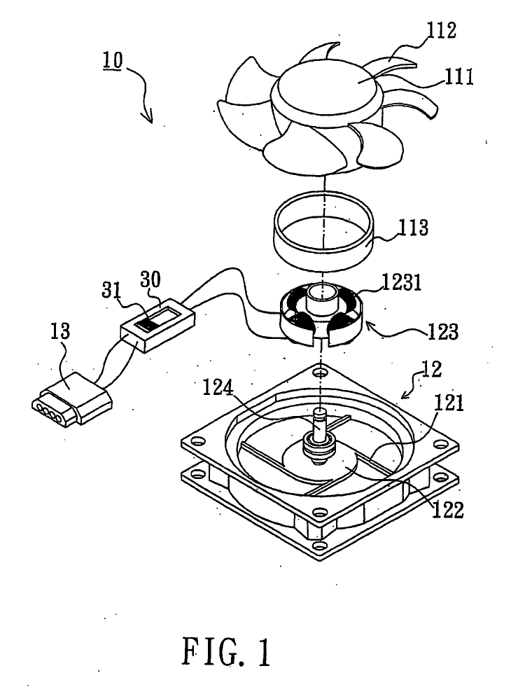

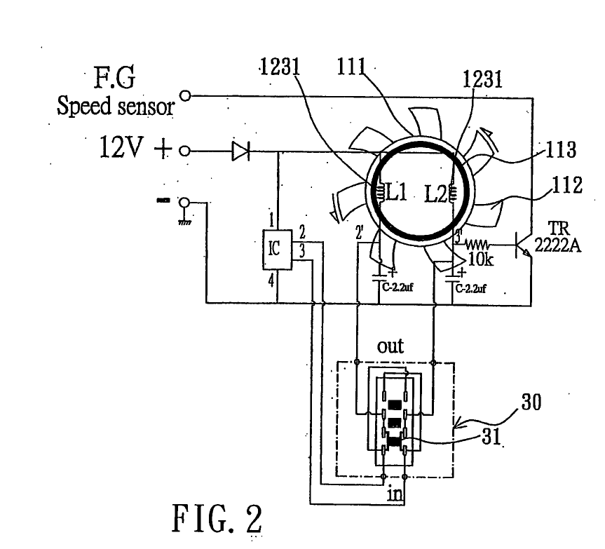

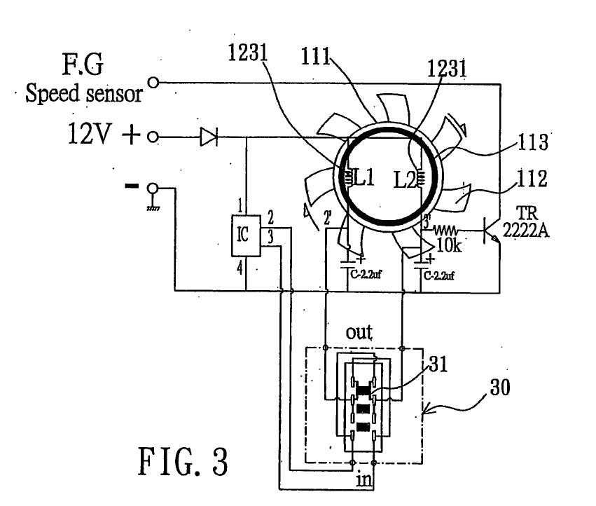

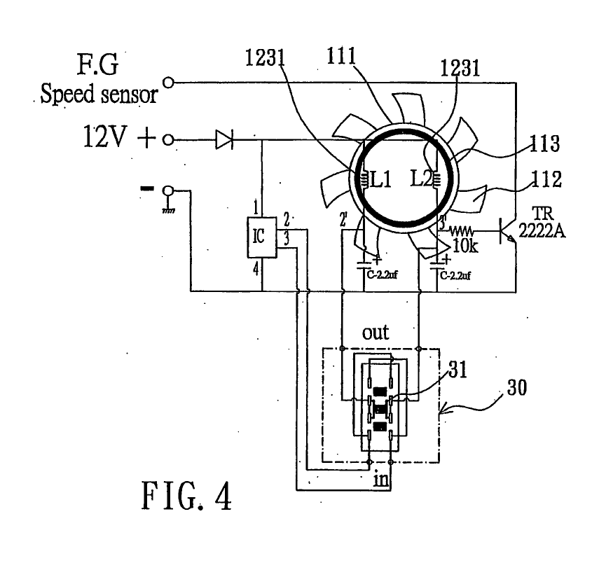

Reference is made to FIGS. 1˜4. FIG. 1 shows a perspective view of the fan of the present invention. FIG. 2 shows a schematic diagram of the circuit of the fan of the present invention with the electric brake of the switch located in a first position. FIG. 3 shows a schematic diagram of the circuit of the fan of the present invention with the electric brake of the switch located in a second position. FIG. 4 shows a schematic diagram of the circuit of the fan of the present invention with the electric brake of the switch located in a third position.

The fan 10 of the present invention is installed in the computer's housing (not shown in the figure), and is used for sucking cool air into the housing and exhausting hot air from the housing. The fan 10 includes a fan leaf 11 and a hollow frame 12 (as shown in FIG. 1). The fan leaf 11 includes a cover 111 and a plurality of leaves 112 uniformly disposed around the surface of the cover 111 to generate airflow. In the interior of the cover 111, there is a rotor 113 having a fixed magnetic field.

A plurality of convex ribs 121 extends from the inner edge of the hollow frame 12 and respectively faces the center of the hollow frame 12, and converges towards the center of the hollow frame 12 to form a base 122 (as shown in FIG. 1). A fastening shaft 124 having a stator 123 located at its upper end protrudes from the surface of the hollow frame 12. The fastening shaft 124 is used for pivoting with the fan leaf 11 and making the rotor 113 cover around the stator 123. The stator 123 includes a plurality of driving coil sets 1231. The driving coil 1231 is connected with the power input terminal 13 to drive the driving coil to generate the magnetic field that repels the stator 123 so that the fan leaf 11 rotates on the fastening shaft 124 of the base 122. The characteristic of the present invention is that there is a current switch 30 located between the driving coil set 1231 and the power input terminal 13. The electric brake 31 of the current switch 30 can be adjusted to two or three positions. When the electric brake 31 of the current switch 30 is switched to the first position, current flows into the induction coil 1321 to make the induction coil 1231 generate a magnetic field. The magnetic filed repels the magnetic filed of the rotor 113 so that the fan leaf 11 rotates clockwise. When the electric brake 31 of the current switch 30 is switched to the second position, the current direction of the induction coil is inverse to the current direction that the electric brake 31 of the current switch 30 is located at the first position. The induction coil 1231 repels the magnetic field of the rotor 113 and the leaves rotate counterclockwise due to the change in the current direction. When the electric brake 31 of the current switch 30 is switched to the third position, the current is shut down and the leaves 112 stop rotating due to the magnetic force of the stator 123 disappearing.

The fan 10 of the present invention is installed in the housing. When the computer has been operating for a long time, the heat generated from the CPU or the display chip is exhausted into the housing via the radiator so that the temperature in the housing rises. At this time, the electric brake 31 of the current switch 30 of the fan 10 is switched to the first position to make the fan leaf 11 rotate clockwise. The hot air in the housing is exhausted to the exterior of housing to lower the temperature. When the electric brake 31 of the current switch 30 is switched to the second position, the current direction of the induction coil is inverse to the current direction that the electric brake 31 of the current switch 30 is located the first position. Thereby, the fan leaf 11 rotates counterclockwise and sucks the cool air into the housing to make the radiator in the housing exhaust the heat effectively.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A fan, comprising:
a fan leaf having a rotor in the interior of the fan leaf; and
a hollow frame, wherein there is a base for pivoting with the fan leaf in the center of the interior of the hollow frame, and there is a stator on the surface of the base, the stator is covered by the rotor;
wherein there is a current switch between the stator and the power input terminal for controlling the current direction of the stator to control the rotating direction of the fan leaf.

2. The fan as claimed in claim 1, wherein the stator comprises a plurality sets of driving coil.

3. The fan as claimed in claim 1, wherein the rotor is a magnet having a fixed magnetic field

4. The fan as claimed in claim 2, wherein when an electric brake of the current switch is switched to the first position, current flows into the driving coil so that the magnetic field of the driving coil repels the magnetic field of the rotor to make the fan leaf rotate clockwise; when the electric brake of the current switch is switched to the second position, the current inversely flows into the driving coil so that the magnetic field of the driving coil repels the magnetic field of the rotor to make the fan leaf rotate counterclockwise.

5. The fan as claimed in claim 4, wherein when the electric brake of the current switch is switched to the third position, the driving coil and the power input terminal is open so that the fan leaf stops rotating.
